(19) United States
(12) Patent Application Publication
(10) Pub. No.: US 2025/0367611 A1
(43) Pub. Date: Dec. 4, 2025

(54) METHOD AND APPARATUS FOR THE PRODUCTION OF AN ION-CONDUCTING MEMBRANE

(71) Applicant: JOHNSON MATTHEY HYDROGEN TECHNOLOGIES LIMITED, London (GB)

(72) Inventors: Angus DICKINSON, Abingdon Oxfordshire (GB); Cameron HAY, Abingdon Oxfordshire (GB); Jake HOWELLS, Swindon (GB); Sinead MCELROY, Swindon (GB); Emily NESLING, Swindon (GB)

(21) Appl. No.: 18/870,239

(22) PCT Filed: Jul. 14, 2023
(86) PCT No.: PCT/GB2023/051850

§ 371 Date: Nov. 27, 2024

(30) Foreign Application Priority Data
Jul. 15, 2022 (GB) 2210452.5

(51) Int. Cl. B01D 71/66; B01D 69/12; B01D 71/02; B01J 37/02

(52) U.S. Cl. CPC B01D 71/66; B01D 69/1216; B01D 71/024; B01J 37/0215

(57) ABSTRACT

A method for the production of an ion-conducting membrane for a water electrolyser or a fuel cell is provided. The method comprises the step of mixing a first liquid stream comprising an ion-conducting polymer and a second liquid stream comprising a cerium-containing compound in-line to form a coating composition. The coating composition is then deposited onto a substrate to form a membrane layer. An apparatus for the production of an ion-conducting membrane for a water electrolyser or a fuel cell is also provided.

### FIELD OF THE INVENTION

The present invention relates to a method for the production of an ion-conducting membrane for an electrochemical device, such as a water electrolyser or a fuel cell, and to apparatus suitable for the manufacture of such ion-conducting membranes.

### BACKGROUND

The electrolysis of water to produce high purity hydrogen and oxygen can be carried out in both alkaline and acidic electrolyte systems. Those electrolysers that employ a solid proton-conducting polymer membrane, or proton exchange membrane (PEM), are known as proton exchange membrane water electrolysers (PEMWEs). Those electrolysers that utilise a solid anion-conducting polymer membrane, or anion exchange membrane (AEM), are known as anion exchange membrane water electrolysers (AEMWEs).

Ion-conducting membranes, such as PEMs and AEMs, are also used in fuel cells. In a proton exchange membrane fuel cell (PEMFC) the membrane is proton conducting, and protons, produced at the anode, are transported across the membrane to the cathode, where they combine with oxygen to form water.

Catalyst coated membranes (CCMs) may be employed within electrochemical devices, such as electrolysers and fuel cells. Such CCMs comprise an ion-conducting membrane, such as a PEM or AEM, with at least one of an anode catalyst layer and a cathode catalyst layer applied to a face of the membrane.

For water electrolyser applications, hydrogen evolution reaction (HER) catalysts are used in such cathode catalyst layers, for example HER catalysts comprising platinum, such as platinum on a carbon support. Oxygen evolution reaction (OER) catalysts are utilised in electrolyser anode catalyst layers. For PEMWE applications, suitable OER catalysts comprise iridium or iridium oxide (IrOx), or oxides containing both iridium and ruthenium. For AEMWE applications, non-platinum group metal OER catalysts may also be used, such as alloys and oxides of nickel, cobalt, iron, and copper.

For fuel cell applications, oxygen reduction reaction (ORR) catalysts are used in cathode catalyst layers and hydrogen oxidation reaction (HOR) catalysts are utilised in anode catalyst layers. For PEMFC applications, suitable cathode and anode catalyst materials comprise a platinum group metal or an alloy of a platinum group metal with one or more other metals, for example platinum or an alloy of platinum with one or more other metals.

Separate film layers, typically formed from non-ion conducting polymers, may be positioned around the edge region of a CCM, for example on exposed surfaces of the ion-conducting membrane where no electrocatalyst is present (but will also often overlap on to the edge of the electrocatalyst layer) to provide a seal to prevent escape of reactant and product gases, to reinforce and strengthen the edge of the CCM and provide a suitable surface for supporting subsequent components such as sub-gaskets or elastomeric gaskets. An adhesive layer may be present on one or both surfaces of the seal film layer.

CCMs may be incorporated into a membrane electrode assembly (MEA), which is essentially composed of five layers. The central layer is the polymer ion-conducting membrane. On either side of the ion-conducting membrane there is an electrocatalyst layer, containing an electrocatalyst designed for the specific electrolytic reaction. Finally, adjacent to each electrocatalyst layer there is a gas diffusion layer or a porous transport layer, depending on the final MEA application and stack configuration. Such layers allow the reactants to reach the electrocatalyst layer and products to leave.

Ion-conducting membranes, such as PEMs and AEMs, are key components of electrochemical devices, such as fuel cells and electrolysers. However, they are subject to significant chemical and mechanical stress during operation which can lead to membrane degradation, which can have a detrimental impact on the performance and maintenance costs of fuel cell and electrolyser stacks.

It is known to add cerium-containing compounds to ion-conducting membranes. Such additives act as scavengers of reactive oxygen species (ROS) which can cause membrane degradation.

WO2007120190 (3M Innovative Properties Company) describes the addition of cerium oxide compounds to fuel cell membranes and the examples show incorporation of cerium oxide in amounts from 0.25 to 1 wt % can lead to improvements in membrane lifetime and reduced fluoride ion evolution (and indicator of membrane degradation).

The use of doped cerium-containing compounds is known. For example, it is described in Baker, A. M. et al, July 2017, Journal of Materials Chemistry A 5(29) that Ce_{0.85}Zr_{0.15}O₂ demonstrates excellent radical scavenging activity. It is described in Venkateshkumar Prabhakaran and Vijay Ramani 2014 J. Electrochem. Soc. 161 F1 that nitrogen-doped CeO₂ has high ROS scavenging activity.

The inclusion of cerium-containing compounds can provide significant difficulties during the manufacture of ion-conducting membranes, in particular achieving the high quality control standards required for ion-conducting membranes used in fuel cell and electrolyser applications due to uneven distribution of the cerium-containing compound in the formed membrane and/or due to the precipitation of particles of the cerium-containing compound during membrane manufacture.

There remains a need to further enhance and develop methods for the production of ion-conducting electrolytic membranes for fuel cells and electrolysers, and for apparatus facilitating the reproducible production of high-quality membranes and CCMs for electrochemical devices.

### SUMMARY OF THE INVENTION

The present inventors have identified that in-line mixing of liquid streams comprising cerium-containing compounds and ion-conducting polymers can be advantageously used during production of ion-conducting membranes for fuel cells and electrolysers, and that this provides a solution to one or more of the hereinbefore mentioned problems.

Therefore, in a first aspect of the invention there is provided a method for the production of an ion-conducting membrane, such as a PEM or an AEM, for a water electrolyser or a fuel cell, the ion-conducting membrane comprising at least one membrane layer, the method comprising the steps of:
a) mixing a first liquid stream comprising an ion-conducting polymer and a second liquid stream comprising a cerium-containing compound in-line to form a coating composition; and
b) depositing the coating composition onto a substrate to form a membrane layer.

The use of in-line mixing offers improvements in the reproducible quality of produced membranes, and a reduction in quality control issues associated with the formation of crystalline particles of cerium-containing compounds during manufacture.

The methods as described herein may have particular utility for the production of catalyst-coated membranes. Therefore, in a second aspect of the invention, there is provided a method of manufacturing a catalyst-coated membrane, the method comprising the steps of:
(i) providing an ion-conducting membrane produced using the method according to the first aspect, the membrane comprising a first face and a second face; and
(ii) forming a catalyst layer on the first and/or the second face of the membrane.

Advantageously, the membranes produced by the method of the first aspect and the catalyst-coated membranes produced by the method of the second aspect are suitable for use in a water electrolyser or a fuel cell.

In a third aspect of the invention, there is provided an apparatus for the production of an ion-conducting membrane for a water electrolyser or a fuel cell, such as an PEM or AEM, the apparatus comprising:
(i) a first source for providing a first liquid stream comprising an ion-conducting polymer;
(ii) a second source for providing a second liquid stream comprising a cerium-containing compound;
(iii) an in-line mixing device in fluid communication with the first source and the second source, the in-line mixing device configured to mix the first liquid stream and the second liquid stream to form a coating composition;
(iv) a coating apparatus configured to receive the coating composition from the in-line mixing device and to coat a substrate with the coating composition to form an ion-conducting membrane layer.

The use of such apparatus offers improvements in reproducible membrane quality and can be used to facilitate the operation of membrane production lines, in particular enabling such lines to be easily stopped and started, without causing membrane quality control issues, and therefore reducing waste.

### BRIEF DESCRIPTION OF THE FIGURES

FIG. 1 shows a schematic representation of an example of an apparatus as described herein.

### DETAILED DESCRIPTION

Preferred and/or optional features of the invention will now be set out. Any of the preferred and/or optional features of any aspect may be combined, either singly or in combination, with any other preferred and/or optional features of any aspect of the invention unless the context demands otherwise.

The present invention provides a method for the production of ion-conducting membranes, for example a proton exchange membrane or an anion exchange membrane, such as for an electrolyser or a fuel cell. It may be preferred that the membrane is a proton exchange membrane for an electrolyser or a fuel cell.

The method comprises the step of in-line mixing a first liquid stream comprising an ion-conducting polymer and a second liquid stream comprising a cerium-containing compound to form a coating composition.

The first liquid stream comprises an ion-conducting polymer. The skilled person will be aware of suitable ion-conducting polymers for the preparation of ion-conducting membranes. The ion-conducting polymer can be a proton-conducting polymer or an anion-conducting polymer, such as a hydroxyl anion-conducting polymer. Examples of suitable proton-conducting polymers include perfluorosulphonic acid ionomers (e.g. Nafion® (E.I. DuPont de Nemours and Co.), Aciplex® (Asahi Kasei), Aquivion™ (Solvay Speciality Polymers), Flemion® (Asahi Glass Co.), or ionomers based on a sulphonated hydrocarbon such as those available from FuMA-Tech GmbH as the fumapem® P, E or K series of products, JSR Corporation, Toyobo Corporation, and others. Examples of suitable anion-conducting polymers include A901 made by Tokuyama Corporation and Fumasep FAA from FuMA-Tech GmbH.

Suitably, the first liquid stream comprises an ion-conducting polymer dispersed in a mixture of water and a polar solvent other than water. The polar solvent can be a polar protic solvent. Preferably, the polar solvent is an alcohol, such as methanol, ethanol, propan-1-ol, propan-2-ol, n-butanol, iso-butanol, butan-2-ol, and tert-butyl alcohol, or a mixture thereof. Preferably, the alcohol is ethanol and/or propan-1-ol. It may be preferred that the first liquid stream comprises (or consists essentially of) at least one ion-conducting polymer, water and an alcohol (such as at least one of ethanol or propan-1-ol).

Typically, the weight ratio of water: polar solvent, such as ethanol and/or propan-1-ol is in the range of an including 9:1 to 1:1, such as 9:1 to 7:3. It will be understood by the skilled person that the solvent ratio may be varied depending on the properties of the chosen ion-conducting polymer.

Typically, the first liquid stream comprises the ion-conducting polymer in an amount in the range of and including 5 to 80 wt. %, preferably 10 to 50 wt. %, preferably 15 to 30 wt. %, and most preferably 15 to 20 wt. % based on the total weight of the components of the first liquid stream.

The second liquid stream comprises a cerium-containing compound. Such compounds are selected as cerium-containing scavengers of reactive oxygen species. Suitably, the cerium-containing compound is a doped or undoped oxide of cerium or a doped or undoped cerium salt. It may be preferred that the cerium-containing compound is a doped or undoped oxide of cerium, such as a doped or undoped cerium (IV) oxide (CeO₂). Suitable dopants may be selected, for example, from one or more transition metals, such as zirconium, or nitrogen. It may be further preferred that the cerium-containing compound is cerium oxide (CeO₂).

Suitably, the second liquid stream comprises the cerium-containing compound in a solvent, such as water, or a mixture of water and a polar solvent other than water, such as a mixture of water and an alcohol, for example a mixture of water and ethanol and/or propan-1-ol. It may be preferred that the solvents used in the first and the second liquid streams are the same. It may be preferred that the second liquid stream comprises the cerium-containing compound in the form of a colloidal sol. The use of the cerium-containing compound in the form of a colloidal sol facilitates dispersion during mixing. Such colloidal sols may comprise additives such as acetic acid and/or nitric acid.

Typically, the cerium-containing compound (e.g. doped or undoped cerium oxide) is present in the second liquid stream in an amount less than 1 wt % based on the total weight of the components of the second liquid stream, such as less than 0.1 wt %, or less than 0.01 wt %. Preferably, the cerium-containing compound (e.g. doped or undoped cerium oxide) is present in the second liquid stream in an amount in the range of and including 0.001 to 0.1 wt. % based on the total weight of the components of the second liquid stream, such as between 0.001 and 0.01 wt %.

It will be understood that the second liquid stream may comprise more than one cerium-containing compound, for example: a doped cerium-containing compound and an undoped cerium-containing compound; two doped cerium-containing compounds with different dopants; or a doped or undoped oxide of cerium and a doped or undoped cerium salt. It will also be understood that the second liquid stream may comprise cerium-containing compounds in more than one form, such as a dissolved cerium-containing compound and a cerium-containing compound in the form of a colloidal sol.

The first and the second liquid streams are mixed in-line. Typically, such in-line mixing comprises adding the second liquid stream into a flowing first liquid stream. Suitably, the second liquid stream is added at a controlled flow rate in order to achieve the desired amount of the cerium-containing compound in the resultant coating composition. Such controlled addition may be provided, for example, by a metering pump.

The in-line mixing may be carried out using a static mixer, such as a pipe mixer or a plate static mixer. It will be understood that the static mixer may comprise inlets for the first and the second liquid streams, or that the first and the second liquid streams may be combined and then the combined streams flowed through a static mixer in order to mix the components.

It will be understood by the skilled person that the in-line mixing of the first and the second liquid streams is carried out such that sufficient mixing is completed prior to the coating composition reaching a coating apparatus, or other apparatus used for membrane preparation.

Suitably, the ratio of the flow rate of the first liquid stream to the flow rate of the second liquid stream at the point of in-line mixing is in the range of and including 5:1 to 15:1, for example in the range of and including 7:1 to 10:1.

After in-line mixing of the first and the second liquid streams to form a coating composition, the method comprises step (b) depositing the coating composition onto a substrate to form a membrane layer.

The coating composition may be deposited using a slot-die coating process (whereby the dispersion is squeezed out by gravity or under pressure via a slot onto the substrate), knife-coating, bar coating, inkjet printing, gravure printing, curtain coating, spray coating, or casting processes. Preferably, the coating composition can be deposited using slot-die coating, bar coating, inkjet printing or gravure printing. Deposition using slot-die coating may be particularly preferred.

The coating composition is deposited onto a substrate to form a membrane layer. In some cases, the ion-conducting membrane is formed from a single membrane layer. Alternatively, the ion-conducting membrane may be formed from two or more layers, such as between two and seven layers. The number of layers will be determined, for example, by the thickness of the desired membrane, and the degree of variation in desired composition across the membrane (for example the membranes may contain one or more layers comprising a reinforcement polymer, such as ePTFE, or an additive, such as a recombination catalyst).

Typically, the substrate is a backing sheet, a second membrane layer, a catalyst layer on a backing sheet, or a catalyst layer on a gas diffusion electrode. It will be understood by the skilled person that the choice of substrate will depend on the structure and stage of production of the membrane.

In the case that the membrane is formed of a single membrane layer, or at the start of production of a multi-layer membrane, the substrate is typically a backing layer. The backing layer provides support for the ion-conducting membrane during manufacture and if not immediately removed, can provide support and strength during any subsequent storage and/or transport. The material from which the backing layer is made should provide the required support, preferably be compatible with the coating composition, preferably be impermeable to the coating composition, be able to withstand the process conditions involved in producing the ion-conducting membrane and be able to be easily removed without damage to the ion-conducting membrane. Examples of materials suitable for use include a fluoropolymer, such as polytetrafluoroethylene (PTFE), ethylene tetrafluoroethylene (ETFE), perfluoroalkoxy polymer (PFA), fluorinated ethylene propylene (FEP—a copolymer of hexafluoropropylene and tetrafluoroethylene), and polyolefins, such as biaxially oriented polypropylene (BOPP).

In some cases in which a catalyst-coated membrane is to be produced, a catalyst layer is provided on a backing layer, for example by printing or using known coating techniques. The coating composition may then be deposited onto the catalyst layer such that the catalyst layer is disposed between the backing layer and the membrane layer formed by depositing the coating composition. The use of the method and apparatus as described herein may be particularly advantageous when the membrane layer is formed on a catalyst layer enabling the provision of a high-quality membrane layer at the interface between the catalyst layer and ion-conducting membrane.

In some cases, typically when the ion-conducting membrane thickness is such that multiple passes are required in order to build up the membrane structure, the substrate is a previously formed membrane layer. It will be understood that the ion-conducting membrane may be formed by sequential deposition of layers. As an example, ion-conducting membranes may be formed as follows. In the first pass, a coating composition as described hereinbefore may be deposited onto a backing layer to form a first ion-conducting polymer layer, which is then dried. In a second pass, the coating composition is deposited onto the first ion-conducting polymer layer to form a second ion-conducting polymer layer. The second ion-conducting polymer layer is then dried. This sequence of application and drying is continued to produce further ion-conducting polymer layers as required to form the desired membrane structure.

Typically, each of the layers in the ion-conducting membrane comprises a cerium-containing compound however it will be understood that in some cases it may be desirable to include membranes layers which are free from cerium-containing compounds (or have a reduced level of cerium-containing compounds). In such cases the use of an apparatus and method as described herein is beneficial as it enables the operator to simply reduce or stop the flow of the second liquid stream during certain deposition passes.

The membranes formed by the method as described herein may be used in the production of catalyst-coated membranes. In such cases, the method may comprise the step of forming a catalyst layer on the first and/or the second face of the membrane to form an anode and/or a cathode. The skilled person will understand that the specific type of catalysts for the cathode and anode are chosen depending on, for example, whether the membrane is for a fuel cell or an electrolyser and whether the membrane is a PEM or an AEM as described previously. Furthermore, the method of deposition can be varied, for example catalyst layers may be transferred to the membrane from a decal, for example by hot pressing, or catalyst inks may be directly printed onto the membrane.

The present invention also provides an apparatus for the production of an ion-conducting membrane.

The apparatus comprises a first source which is in fluid communication with an in-line mixing device. The first source provides a first liquid stream comprising an ion-conducting polymer. Typically, the first source is a vessel containing a dispersion of at least one ion-conducting polymer in a solvent, or a mixture of solvents. Preferably, the vessel is configured to agitate the contents, for example by stirring or shaking.

Suitably, the apparatus is provided with a first pump configured to transfer the contents of the first source as a first liquid stream to the in-line mixing device at a controlled flow rate. Preferably, the apparatus is further configured such that that the first liquid stream passes through a filter prior to reaching the in-line mixing device.

The apparatus comprises a second source which is in fluid communication with the in-line mixing device. The second source provides a second liquid stream comprising a cerium-containing compound. Typically, the second source is a vessel containing the cerium-containing compound in a solvent, such as water, or a mixture of solvents. Preferably, the vessel is configured to agitate the contents, for example by stirring or shaking.

Suitably, the apparatus is provided with a second pump configured to transfer the contents of the second source as a second liquid stream to the in-line mixing device at a controlled flow rate. Preferably, the apparatus is further configured such that that the second liquid stream passes through a filter prior to reaching the in-line mixing device.

The apparatus comprises an in-line mixing device configured to mix the first liquid stream and the second liquid stream to form a coating composition. Suitably, the in-line mixing device is configured such that the second liquid stream is added to the flowing first liquid stream.

It may be preferred that the in-line mixing device is a static mixer, such as a pipe mixer or plate static mixer. The static mixer may comprise a first inlet for receiving the first liquid stream and a second inlet for receiving the second liquid stream. As an alternative, the apparatus may be configured such that the second liquid stream is added to the first liquid stream and then the combined first and second liquid streams pass through the static mixer.

The apparatus comprises a coating apparatus configured to coat a substrate with the coating composition to form an ion-conducting membrane. For the avoidance of doubt, the apparatus is configured such that the outlet of the in-line mixing device is in fluid communication with the inlet of the coating apparatus. The coating apparatus may be any apparatus suitable for the formation of an ion-conducting membrane on a substrate. Such apparatus is known to the skilled person and include a slot-die coater, a bar coater, a knife-over-roll coater, an inkjet printer or a gravure printer.

It is preferred that the in-line mixing device is located in close proximity to the inlet of the coating apparatus. It may be preferred that that the apparatus is configured such that the transit time of the coating composition between the outlet of the in-line mixing device and the inlet of the coating apparatus is less than 60 seconds, such as less than 30 seconds, less than 15 seconds, or less than 10 seconds. It may be preferred that that the apparatus is configured such that the transit time of the coating composition between the outlet of the in-line mixing device and the inlet of the coating apparatus is in the range of and including 1 and 60 seconds, preferably in the range of and including 1 and 30 seconds, or 1 and 10 seconds.

Typically, the apparatus comprises a device for drying the membrane layer after formation by the coating apparatus. Such devices are known to the skilled person and include ovens and infrared dryers.

It may be preferred that the apparatus comprises an analytical device for analysing the chemical composition of the membrane layer after formation, and in particular cerium content in the membrane as the membrane is produced. Suitably the device is an x-ray fluorescence (XRF) detector. Advantageously, the apparatus is configured such that the flow rate of the second liquid stream is adjusted automatically based on cerium content detected in the membrane by the analytical device.

Preferably, the apparatus additionally comprises a purge line which is configured to enable removal of the coating composition from parts of the apparatus downstream of the static mixer (and upstream of the coating apparatus). This enables the coating composition to be drained from the apparatus in the event of an apparatus shutdown or between coating runs, and avoids problems with potential crystallisation of the cerium-containing compound during periods when the apparatus is not being operated.

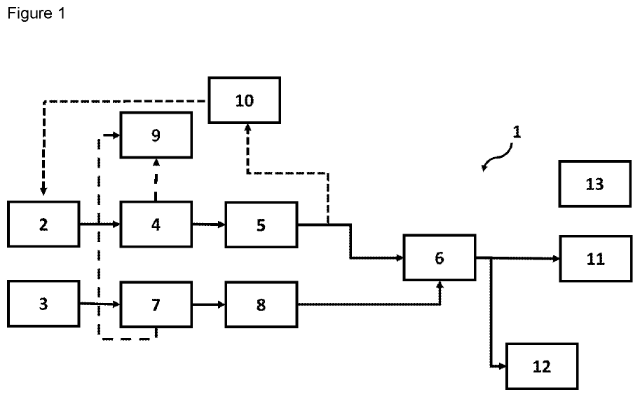

FIG. 1 shows an example of an apparatus (1) for the production of an ion-conducting membrane. The apparatus (1) comprises a first tank (2) which acts as a source of a dispersion of ion-conducting polymer in solvent (for example a mixture of water and ethanol) and a second tank (3) which acts as a source of cerium oxide in solvent (such as a mixture of water and ethanol). A first pump (4) pumps the dispersion of ion-conducting polymer from tank (2), optionally through an in-line filter (5), towards a static mixer (6). A second pump (7) pumps the cerium-containing stream, optionally through an in-line filter (8), towards the static mixer (6). The first pump (4) and the second pump (7) are preferably controlled by a human machine interface (9) which may be used to, for example, adjust flow rates. The apparatus may contain means (10) to divert flow of the dispersion of ion-conducting polymer to the tank (2). The static mixer (6) mixes the two liquid feeds to form a coating composition which proceeds to coating head (11) of a coating apparatus, such as a slot die coater, which deposits the coating composition on a substrate to form a membrane, for example onto a backing layer. The membrane is dried after formation to remove solvent, for example by passing through a heater (not shown on FIG. 1) at a temperature of, for example, 80° C. It is preferred that the apparatus comprises a valve (12) connected to a purge line enabling a purge of the line between the static mixer and coating head so that if the coating line is stopped the mixed composition may be discarded prior to restarting the apparatus. The formed membrane is analysed in situ by an X-ray fluorescence analyser (13) which determines the cerium content of the membrane. Advantageously, the apparatus (1) is configured such that the speed of the first pump (7) is automatically adjusted based on data from the X-ray fluorescence analyser (13).

1. A method for the production of an ion-conducting membrane for a water electrolyser or a fuel cell, the ion-conducting membrane comprising at least one membrane layer, the method comprising the steps of:
(a) mixing a first liquid stream comprising an ion-conducting polymer and a second liquid stream comprising a cerium-containing compound in-line to form a coating composition; and
(b) depositing the coating composition onto a substrate to form a membrane layer.

2. A method according to claim 1, wherein the first liquid stream comprises a dispersion of an ion-conducting polymer in a mixture of water and a polar solvent other than water.

3. A method according to claim 1, wherein the second liquid stream comprises the cerium-containing compound in the form of a colloidal sol.

4. A method according to claim 1, wherein the cerium-containing compound is a doped or undoped oxide of cerium.

5. A method according claim 1, wherein the substrate is selected from a backing sheet, a second membrane layer, or a catalyst layer on a backing sheet.

6. A method according to claim 1, wherein the in-line mixing in step (a) is carried out using a using a static mixer.

7. A method according to claim 1, wherein ratio of the flow rate of the first liquid stream to the flow rate of the second liquid stream is in the range of and including 7:1 to 15:1.

8. A method according to claim 1, further comprising step (c) drying the membrane layer.

9. A method according to claim 1, further comprising the steps:
(d) depositing the coating composition onto the membrane layer to form an additional membrane layer; and
(e) drying the additional membrane layer.

10. A method according to claim 9, wherein steps (d) and (e) are repeated between 1 and 6 times.

11. A method according to claim 1 wherein the ion-conducting membrane is a proton-exchange membrane.

12. A method of manufacturing a catalyst-coated membrane, the method comprising the steps of:
(i) providing an ion-conducting membrane produced according to claim 1, the membrane comprising a first face and a second face; and
(ii) forming a catalyst layer on the first and/or the second face of the membrane.

13. A method according to claim 12 further comprising the step of applying a seal material to the first face and/or the second face of the catalyst-coated membrane.

14. A method according to claim 12 further comprising the step of applying a gas diffusion layer and/or a porous transport layer onto the first and/or second faces of the catalyst-coated membrane.

15. An apparatus for the production of an ion-conducting membrane for a fuel cell or an electrolyser, the apparatus comprising:
(i) a first source for providing a first liquid stream comprising an ion-conducting polymer;
(ii) a second source for providing a second liquid stream comprising a cerium-containing compound;
(iii) an in-line mixing device which is in fluid communication with the first source and the second source, the in-line mixing device configured to mix the first liquid steam and the second liquid stream to form a coating composition; and
(iv) a coating apparatus configured to receive the coating composition from the in-line mixing device and to coat a substrate with the coating composition to form an ion-conducting membrane layer.

16. An apparatus according to claim 15, wherein the in-line mixing device is a static mixer.

17. An apparatus according to claim 15, wherein the coating apparatus is a slot-die coater, a bar coater, an inkjet printer or a gravure printer.

18. An apparatus according to claim 15, further comprising an analytical device for the analysis of the cerium content in the membrane layer as the membrane layer is produced.

19. An apparatus according to claim 18 wherein the apparatus is configured such that the flow rate of the second liquid stream is adjusted automatically based on the cerium content detected in the membrane layer by the analytical device.

20. An apparatus according to claim 15, wherein the apparatus is configured such that the transit time of the coating composition between the outlet of the in-line mixing device and the inlet of the coating apparatus is less than 60 seconds, such as less than 30 seconds, or less than 10 seconds.
